(19) United States
(12) Patent Application Publication
(10) Pub. No.: US 2025/0108985 A1
(43) Pub. Date: Apr. 3, 2025

(54) DEVICE FOR LOADING FLAT ELEMENTS ONTO A WORK TABLE OF A MACHINE TOOL

(71) Applicant: MURATORI MACHINES S.R.L., SERRAVALLE (SM)

(72) Inventor: Antonio MURATORI, SERRAVALLE (SM)

(21) Appl. No.: 18/832,816

(22) PCT Filed: Jan. 30, 2023
(86) PCT No.: PCT/IB2023/050775

§ 371 Date: Jul. 24, 2024

(30) Foreign Application Priority Data
Jan. 31, 2022 (IT) 102022000001619
Jul. 20, 2022 (IT) 102022000015288
Jan. 18, 2023 (IT) 102023000000690

(51) Int. Cl. B65G 65/00

(52) U.S. Cl. CPC B65G 65/00; B65G 2201/022

(57) ABSTRACT

The present invention concerns a device for loading flat elements onto a work table (P) of a machine tool, the device comprising a supporting structure (12, 112) defining a supporting surface (14, 114) and at least one lifting arm (22, 122) provided with pick-up means (24, 124) adapted to pick up a panel (26) from a stack (28) of panels, wherein said lifting arm (22, 122) is formed by articulated elements and wherein said pick-up means (24, 124) are configured to rotate the panel so that said the lifting arm can, in a first release position, position said panel with the first face (A) facing the supporting surface (14) or, in a second release position, position said panel with said first face (A) facing in the opposite direction, i.e., facing outward.

The present invention relates to a device for loading flat elements, such as panels or sheets, onto a machine tool.

More in particular, the invention relates to a device for loading panels or sheets onto a machining centre with vertical or horizontal table.

In the machine tool sector, machining centres are known called “vertical table”, or “vertical panel” saws, as they are provided with a work table that is substantially vertical, i.e., more or less perpendicular to the ground.

Machine tools of this type are advantageous in some applications as they make it possible to obtain reduced overall dimensions of the surface of the machine and at the same time offer optimal access to the work area by the operator.

These machines thus configured are used in particular to machine flat elements, such as panels or sheets, made of different materials, such as wood, metal or composite materials.

In particular, these composite panels are more and more widely used in a variety of sectors, from the building to the furnishing sector, thanks to their capacity to exploit the qualities of the individual combined materials.

A very significant example on the market is represented by composite panels, a few millimetres thick, consisting of a core made of plastic material enclosed between two metal sheets (aluminium or steel), which are used today to produce furniture, domestic appliances, but also for building facades or for signs.

In addition to the above, fibre cement panels and HPL panels are currently used increasingly in the building and furnishing sector.

As a function of requirements, a series of machining operations are carried out on these panels to obtain the desired finished product.

Typical machining operations are, for example, cutting, contour milling, slot milling and boring, and can be carried out by machining centres with interpolating axes, such as those described above.

Generally, these panels have at least one “good” face, i.e. coated, painted or treated, and hence with a more prestigious aesthetic finish, which remains visible in the finished product, and an opposite face with a less prestigious finish on which the aforesaid machining operations are carried out.

To carry out these machining operations, the panel is positioned and blocked by means of a vacuum pressure system, with said “good” face in contact with the work table of the machine, more specifically with the “sacrificial panel”, where a machining head with three or more axes operates the tools that machine the opposite face by stock removal.

A problem that is encountered in the use of these machines in particular concerns the step of loading blank panels, of considerable size and weight, onto said work table of the machine tool

In fact, these panels are generally supplied by the manufacturers in stacks of a few tens of pieces on pallets, which are placed on the ground close to the machining area.

EP 2492224 B1, by the same applicant, describes a loading device suitable to autonomously pick up and load panels such as those described above onto the work table of a vertical machining centre.

The limit of this device is that it can only operate with stacks of panels with the “good” face facing upward.

However, increasingly frequently the stacks of these panels are supplied with different orientations of the “good” faces, i.e., said surfaces of the panels can all be facing in the same direction or, at times, they can be facing toward or away from each other. In practice, the panels, in alternating pairs, have the good faces or the opposite less prestigious faces facing each other.

In these conditions it is not possible to use a loading device according to the prior art without first rearranging the orientation of the panels, i.e., arranging them all with the “good” face facing upward.

For these reasons, this operation is currently carried out completely manually by two or more operators, who pick up one panel at a time from the stack and place it on another pallet to form an orderly stack, i.e., with the “good” faces all facing upward, therefore in a position that allows said panel to then be placed on the work table by a known loading device.

However, these panels, especially those used in the building sector, are of limited thickness, even less than 10 mm, but can reach sizes of up to 10 metres in length and up to 2 metres in height, with a weight of over 30 kilograms.

In these cases, the handling and loading operations are difficult and require the intervention of at least two or more operators.

Moreover, due to the high flexibility of the materials there is often the risk of deforming the panel, of damaging the “good” face following impacts or similar, or of injury to operators during the loading operation.

In this context, the object of the present invention is to propose a device for loading flat elements, such as panels or sheets, onto a machine tool, in particular a vertical or a horizontal machining centre, which overcomes the drawbacks of prior art.

In detail, the object of the invention is to propose a device for loading flat elements, in particular panels, onto a machining centre, which allows manual operations by the operator to be minimized.

In particular, the object of the present invention is to propose an automated device capable of picking up a panel from a stack, not previously arranged, i.e., with the “good” faces of the panels positioned facing upward or downward without distinction, arranging it for loading onto the work table of the machine tool.

A further object of the present invention is to propose a device that allows a single operator to manage the operations of loading panels onto the machine tool, without any physical exertion and without any risk.

These specified objects are substantially achieved by a device adapted to load flat elements onto a work table of a machine tool in conformity with the appended claim 1.

According to a typical mode of use of the device, the machine tool onto which the panels are loaded has a work table typically substantially vertical, or, in any case, transverse to the ground.

According to another embodiment of the invention, the device is configured to arrange the panel for loading onto a machine tool that has a horizontal work table.

In particular, according to the invention, the device comprises:
a supporting structure, defining a supporting surface adapted to receive a panel in position to be able to be loaded onto the work table P of the machine tool; and
at least one lifting arm, connected to the supporting structure, provided with pick-up means.

The lifting arm is configured to pick up a panel from a stack of panels and to position said panel on the supporting surface of the supporting structure.

According to the invention, the lifting arm comprises articulated elements that allow the pick-up means to rotate relative to a horizontal axis and parallel to the supporting surface.

In detail, said articulated elements are rigid elements, for example rods, arms, etc.

In this way, the lifting arm, in a pick-up position, can grip the panel by a first face facing upward, and, in a first release position, can position said panel on the supporting surface with the first face facing it.

In a second release position, the lifting arm can position said panel on said supporting surface with said first face in the opposite direction, i.e., facing outward.

Thanks to this configuration, during release of the panel onto the supporting surface, the pick-up means can be arranged according to two different configurations.

In the first configuration, the pick-up means are beyond the supporting surface, i.e., toward the inside of the supporting structure, to release the panel with the first face facing said supporting surface. In the second configuration, said pick-up means are rotated and are arranged outside the supporting surface, to release the panel with the first face facing outward.

In this way, the device can operate indifferently with stacks of panels where the “good” faces are all facing upward or downward or with mixed stacks where the good faces and the opposite faces are facing in alternating pairs.

According to an aspect of the invention, the device comprises a movable support, which can move along a substantially vertical direction, or, in any case, transverse to the ground, to which said lifting arm is hinged.

According to another variant of the device according to the invention, destined to serve a horizontal machining centre, said movable support can move along a substantially horizontal direction.

Preferably, but not necessarily, said movable support moves along a direction parallel to the supporting surface of the supporting structure.

The movement in height and/or to the side of the movable support allows the lifting arm and the pick-up means to rotate the panel between the pick-up and release position, as a function of the required positioning, without it being possible for the panel to impact the supporting structure or the stack of panels on the ground.

Moreover, this configuration allows a simpler lifting arm to be produced, for example formed by elements articulated simply by means of hinges.

The movable support, the lifting arm and the pick-up means are equipped with actuators, for example numerically controlled electronic actuators or pneumatic actuators, which control their movements and/or rotations.

According to the invention, at least two or more lifting arms are preferably provided, equipped with respective pick-up means, as a function of the sizes of the panels to be moved.

According to another aspect of the invention, each lifting arm comprises a manipulating arm to which the pick-up means are rotatably connected. More in detail, according to a preferred variant, said pick-up means comprise a support arm and a plurality of vacuum suction cups. Said suction cups are in communication with a vacuum device.

According to an aspect of the invention, the support arm is provided with at least one assembly of suction cups comprising at least one row of suction cups aligned along the direction of extension of the support arm.

According to a variant of the invention, said pick-up means comprise at least two assemblies of suction cups. The suction cups of each assembly are arranged aligned along respective pick-up surfaces, generally staggered and not necessarily parallel. In this way, the lifting arm can grip the panel when the support arm is substantially parallel thereto but in two positions rotated angularly through approximately 180° relative to each other.

This configuration of the support arm is particularly useful in the variant of the device with horizontal supporting surface as it allows panels to be picked up indifferently from two stacks arranged at the opposite sides of the fixed structure.

According to another variant of the invention, a further spacer arm is interposed between the manipulating arm and the pick-up means, more specifically the support arm. The ends of the spacer arm are hinged to the manipulating arm and to the support arm, respectively.

As will be explained in more detail below, this configuration allows, especially in the version of the device with horizontal supporting surface, gripping of the panel with a larger number of suction cups and, at the same time, arrangement of the stacks of panels closer to the device, further reducing the overall dimensions of the device in the using configuration.

According to another aspect of the invention, the movable support comprises a carriage mounted sliding on a guide supported by the supporting structure. The manipulating arm is connected at one end thereof rotatably to said carriage.

More in detail, according to a first variant of the invention, said guide extends prevalently vertically and is preferably oriented so that the carriage moves along a direction parallel to the supporting surface.

According to another variant of the device, suitable to serve a machine tool with horizontal work table, said guide extends substantially horizontally.

According to another aspect of the invention, the guide is mounted on the supporting structure slidable along a transverse direction, i.e., horizontal and parallel to the supporting surface.

According to the variant of the invention in which the device has the supporting surface arranged horizontally, the guide extends substantially horizontally and can be, in turn, slidable relative to the supporting structure along a direction transverse to the direction of sliding of the carriage on the guide.

This transverse movement allows the lateral position of the one or more lifting arms of the device to be adjusted to adapt to the position of the stack of panels on the ground and/or to their size.

According to another aspect of the invention, in the variant of the device in which the supporting surface is substantially vertical, support means adapted to support the panel in the release position are also provided.

Said support means can, for example, comprise at least one pair of pins protruding beyond the supporting surface and movable parallel thereto between a rest position, in which they allow the panel to rest on said surface, and an operating position, where they are carried into contact with a lower edge of the panel to support it.

In this way, once the panel is supported by said pins, the pick-up means can be deactivated to release their grip and allow the panel to be taken to the height of the lower stops of the work table of the machine.

For this purpose, said support means are provided with sliding means adapted to allow sliding of said panel from said supporting surface of the device to the work table of the machine tool without any difficulty and without any effort.

Thanks to the present invention it is thus possible to produce a device that allows flat elements, such as sheets or panels, to be picked up and moved from a stack, to be loaded onto a machine tool.

The device thus configured can operate with panels of various formats without requiring any adjustments and without requiring the intervention of the operator.

The system is almost totally automated and therefore allows a single operator to position the panel on the work table of the machine without any difficulty and without any effort, with the possibility of choosing the side of the panel to be subjected to machining.

Other features and advantages will be more apparent in the indicative and, hence non-limiting, description of a preferred, but not exclusive, example of embodiment of the invention, as illustrated in the accompanying drawings, wherein:

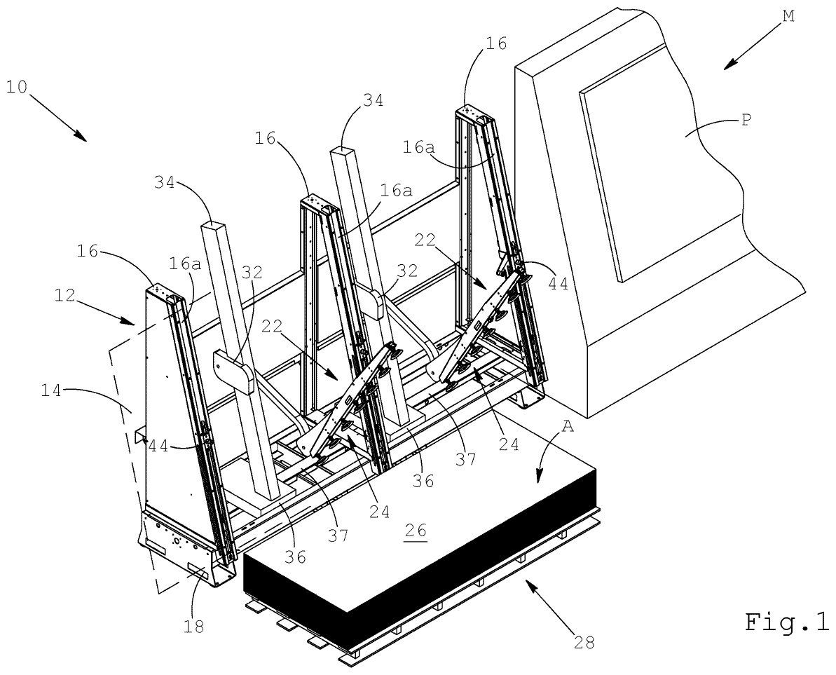

FIG. 1 is a perspective view of a device for loading flat elements onto a machine tool, according to a first embodiment of the invention;

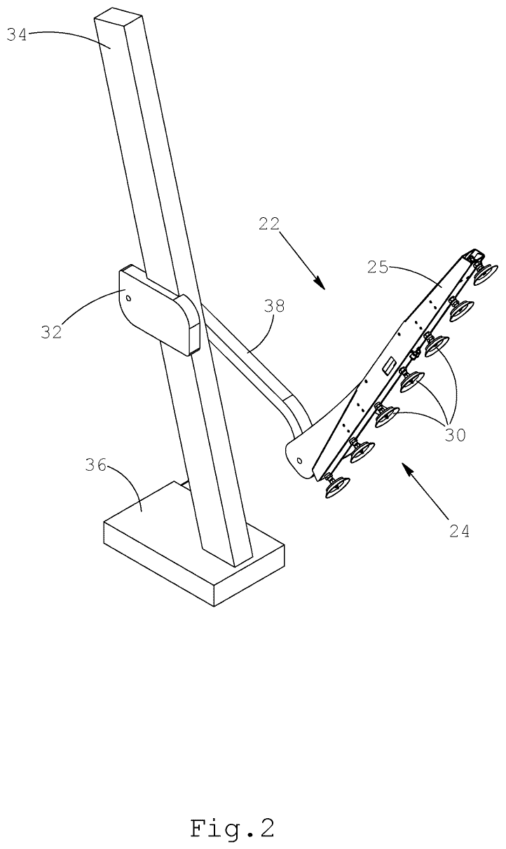

FIG. 2 is a view of a detail of the lifting arm of the device of FIG. 1;

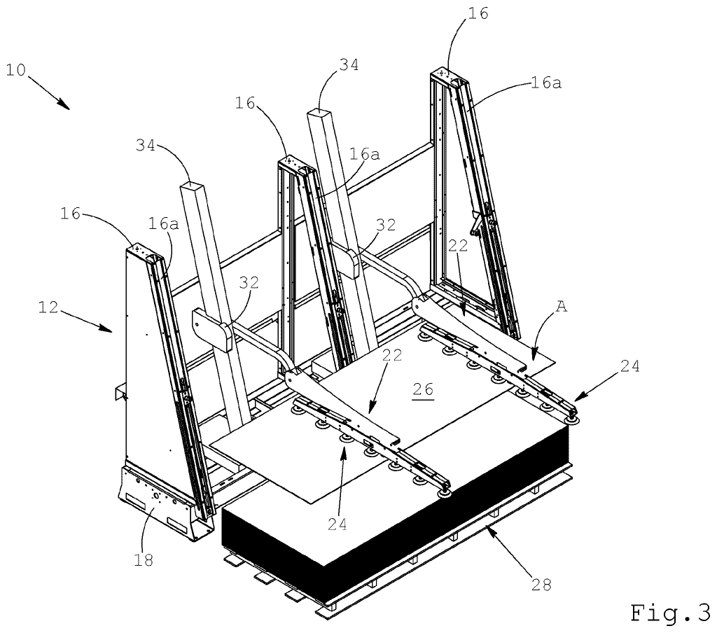

FIG. 3 is a perspective view of the device of FIG. 1 during the step of picking up and lifting a panel from a stack;

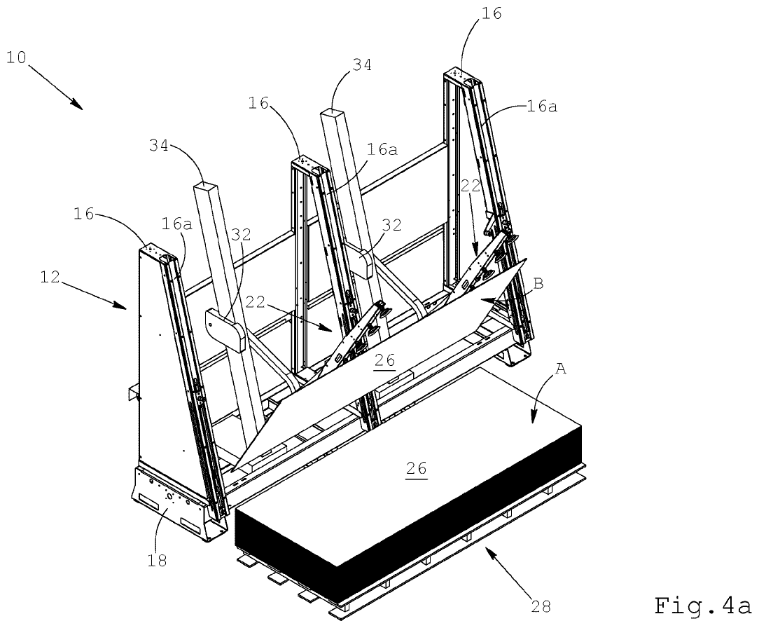

FIGS. 4a and 4b are perspective views of the device of FIG. 1 during the step of releasing the panel onto the supporting surface of the device, according to a first operating configuration;

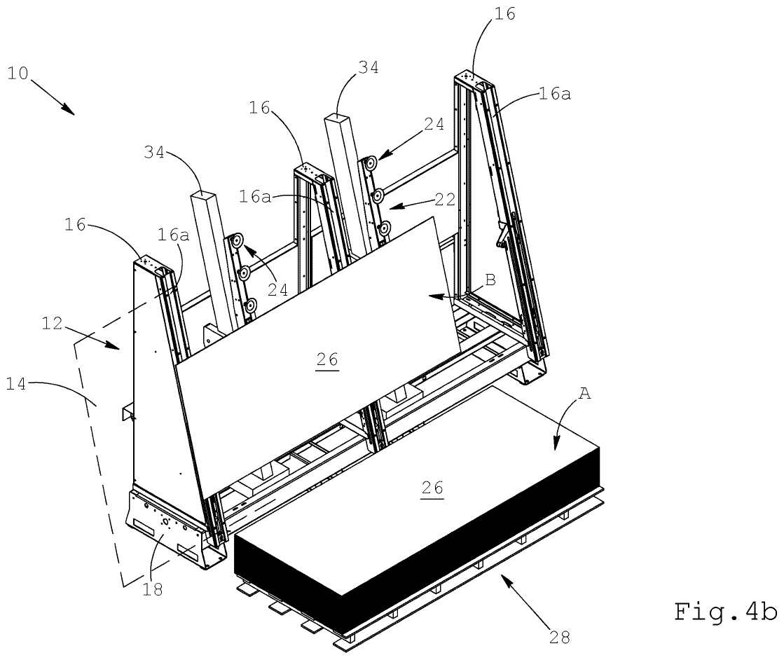

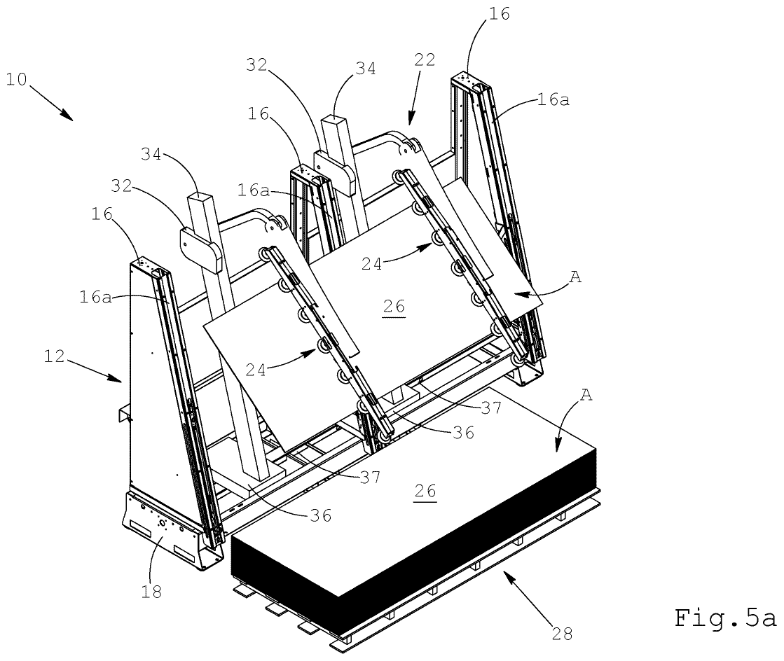

FIGS. 5a and 5b are perspective views of the device of FIG. 1 during the step of releasing the panel onto the supporting surface of the device, according to a second operating configuration;

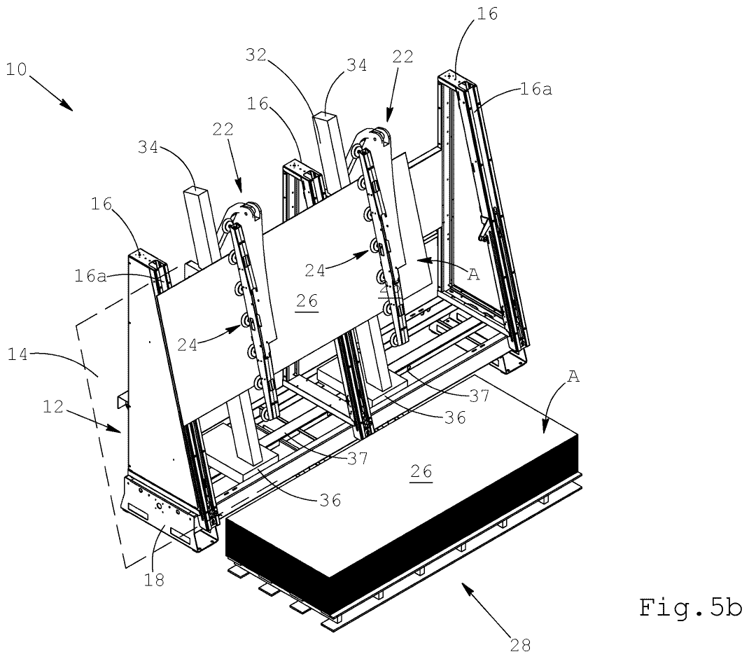

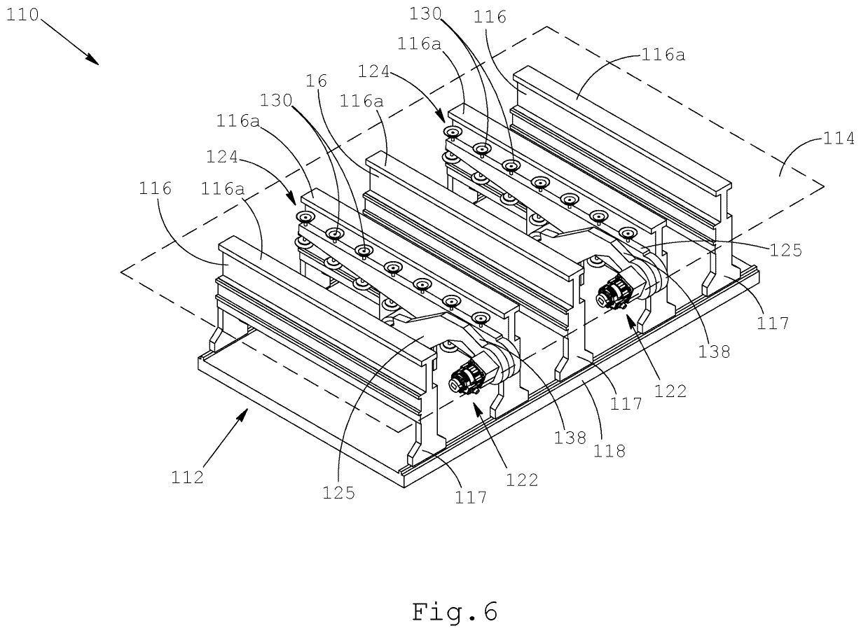

FIG. 6 is a perspective view of a device for moving flat elements according to another embodiment of the invention, in a rest position;

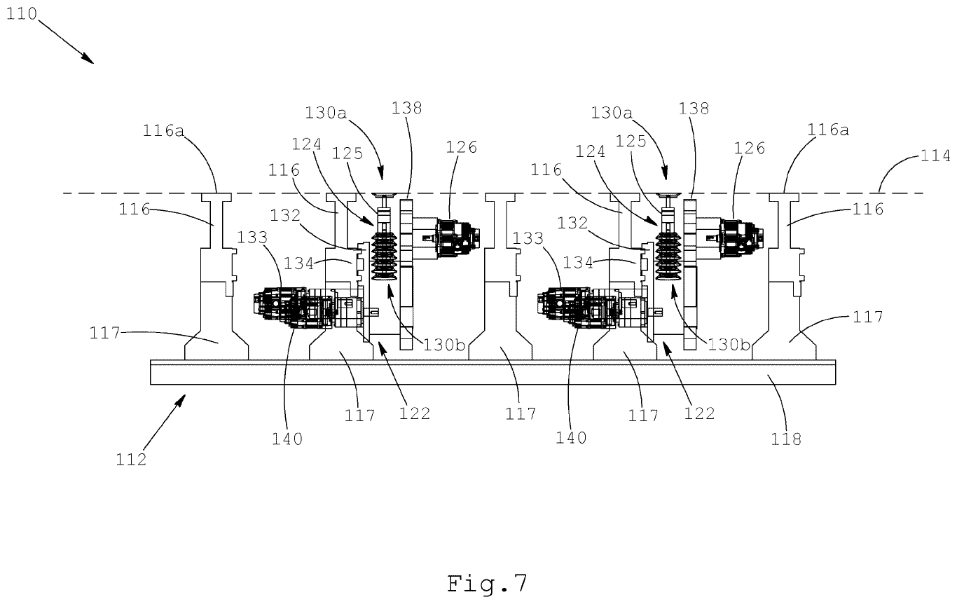

FIG. 7 is a front view of the device of FIG. 6;

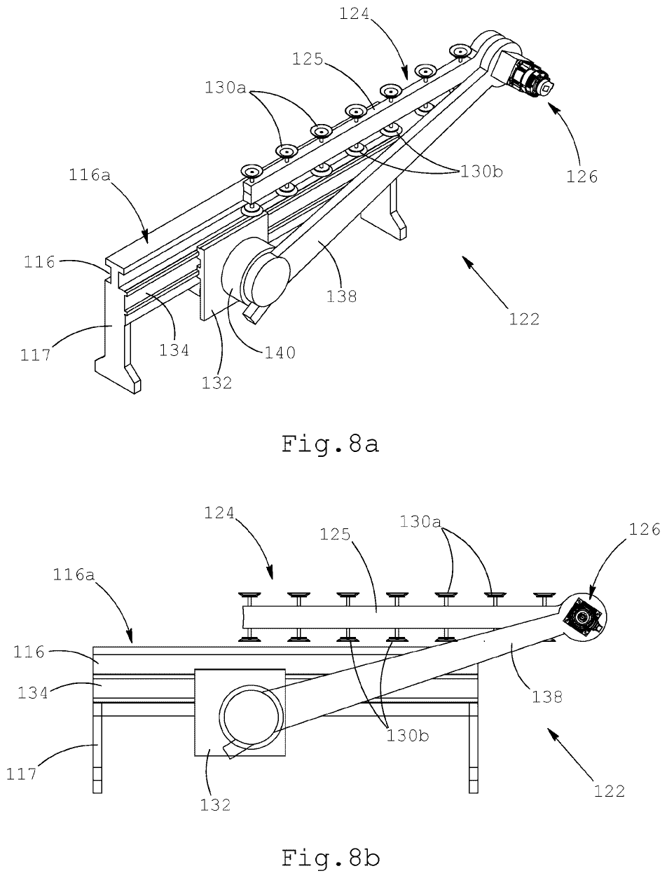

FIGS. 8a, 8b are respectively a perspective view and a side view of the lifting arm of the device of FIG. 6, in an operating position;

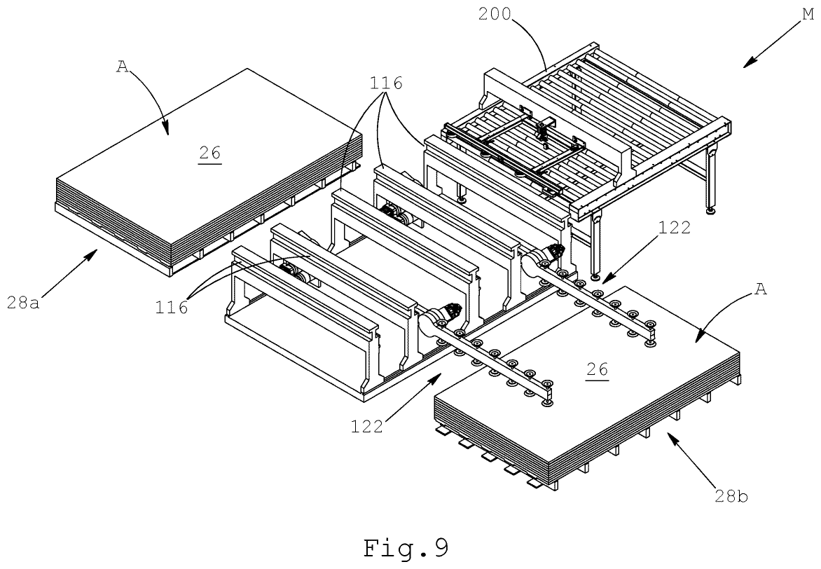

FIG. 9 is a perspective view of the device of FIG. 6, in an operating configuration;

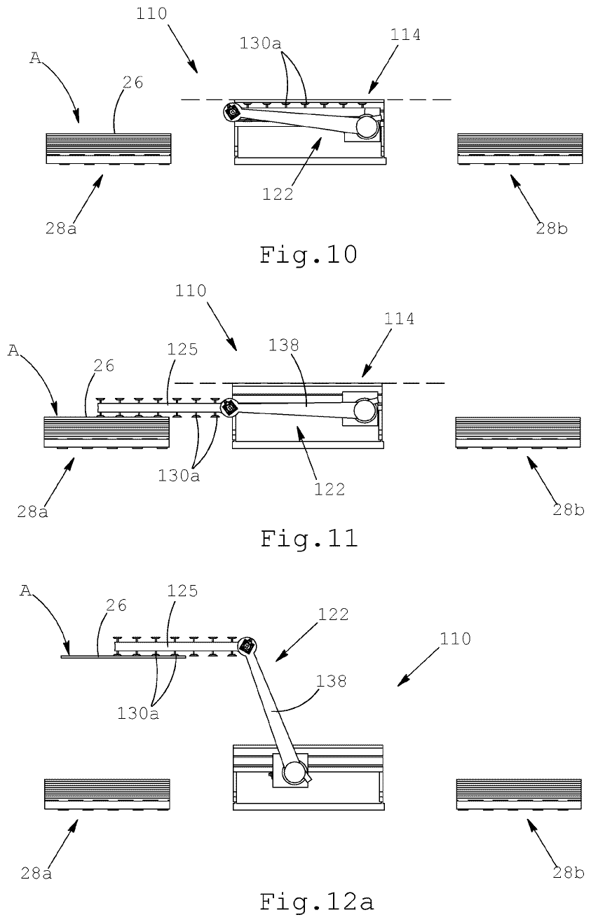

FIG. 10 is a front view of the device of FIG. 6 in a rest position;

FIG. 11 is a front view of the device of FIG. 10 during the step of picking up and lifting a panel from a stack;

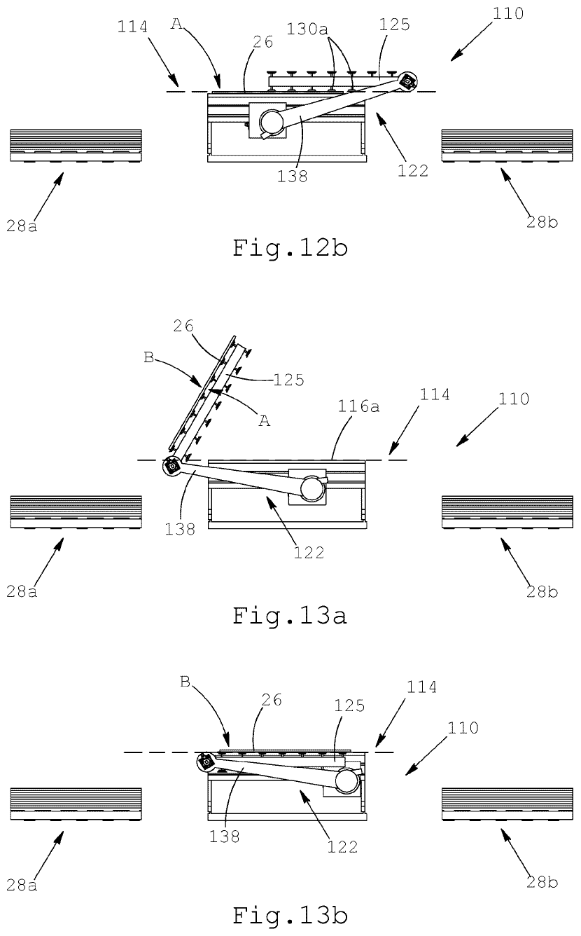

FIGS. 12a and 12b are front views of the device of FIG. 10 during the step of releasing the panel onto the supporting surface of the device, according to a first operating configuration;

FIGS. 13a and 13b are front views of the device of FIG. 10 during the step of releasing the panel onto the supporting surface of the device, according to a second operating configuration;

FIG. 14 is a front view of the device of FIG. 10 during the step of picking up and lifting a panel from another stack;

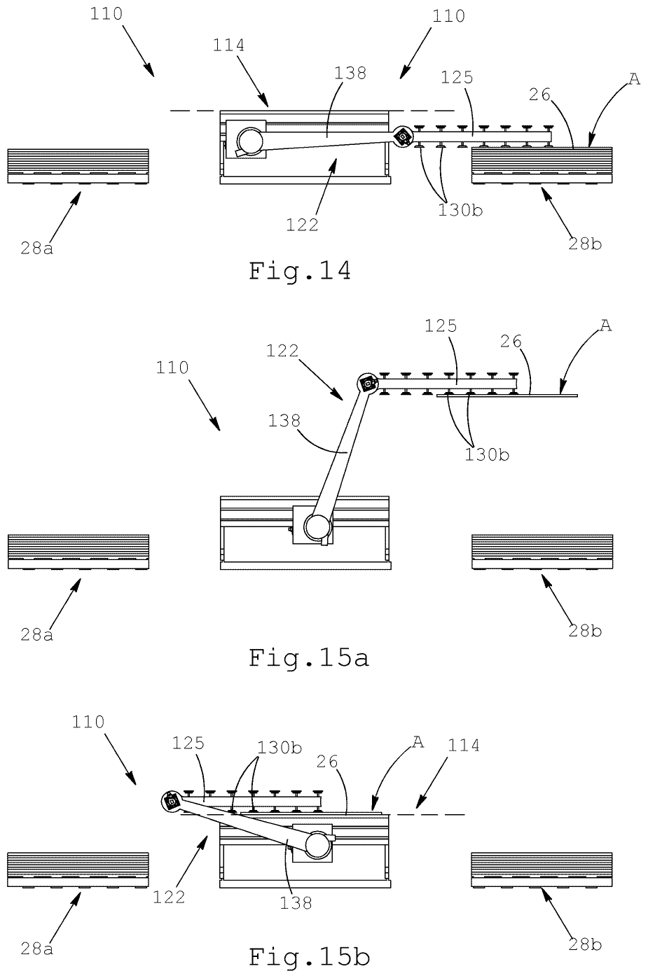

FIGS. 15a and 15b are front views of the device of FIG. 14 during the steps of releasing the panel onto the supporting surface of the device, according to a first operating configuration;

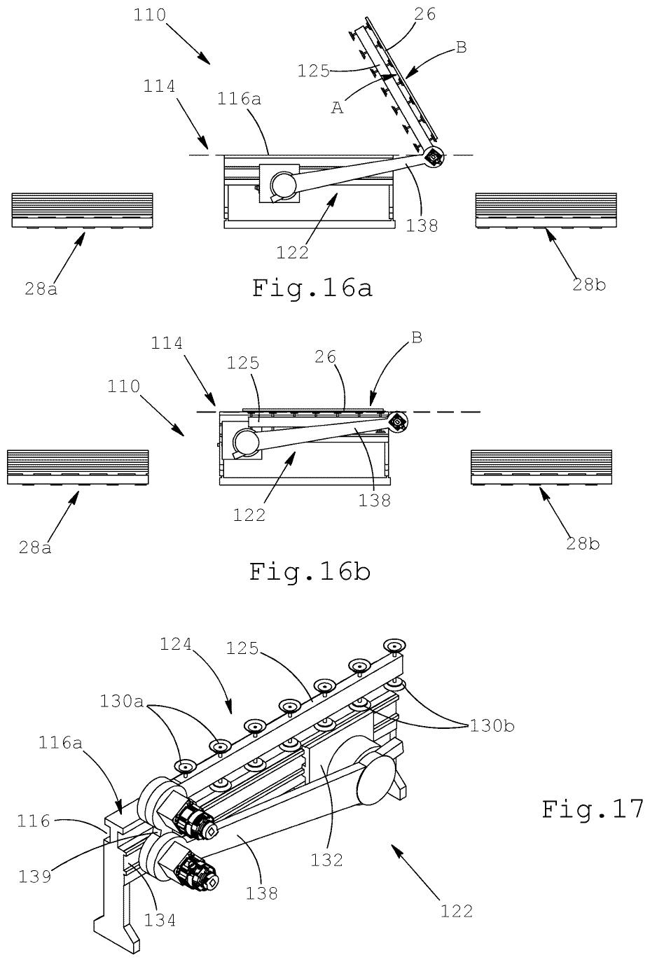

FIGS. 16a and 16b are front views of the device of FIG. 14 during the steps of releasing the panel onto the supporting surface of the device, according to a second operating configuration;

FIG. 17 is a perspective view of the lifting arm of the device, according to another variant of the invention;

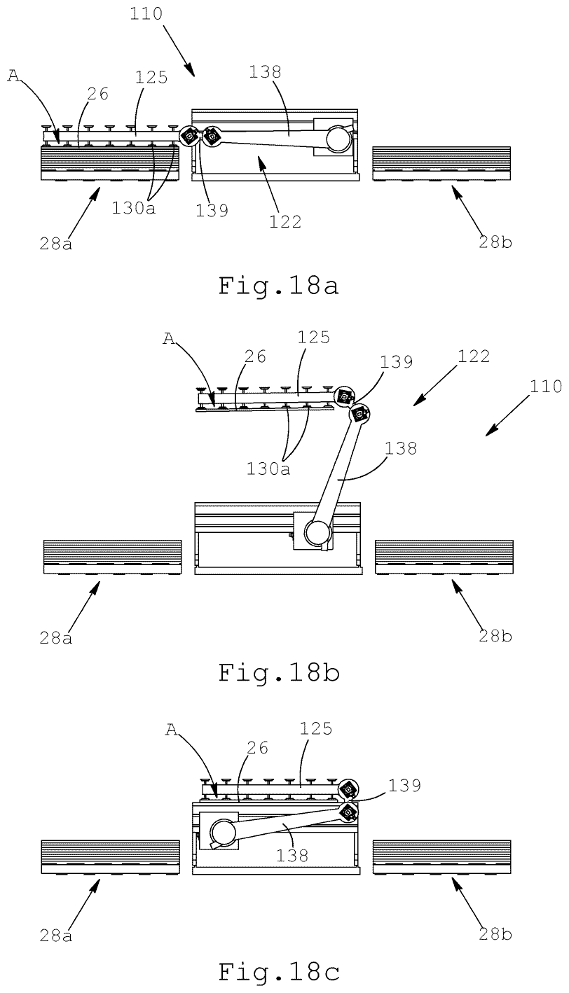

FIGS. 18a to 18c are front views of the device equipped with the arms of FIG. 17, during the steps of picking up the panel and releasing it onto the supporting surface of the device, according to a first operating configuration.

With reference to the accompanying FIG. 1, the device for loading flat elements onto a machine tool, indicated as a whole with 10, comprises a supporting structure 12 that defines a supporting surface 14 substantially parallel to a work table P of a machine tool M.

In detail, said machine tool M is a vertical machining centre in which the work table P is inclined by an angle generally between 95° and 125° relative to the ground on the side of the working zone, i.e., the side for loading the panel.

The loading device according to the invention is designed to be placed next to the machine tool, as illustrated in FIG. 1, so that said supporting surface 14 is substantially parallel to and coplanar with the work table P of the machine M.

According to a preferred embodiment, said supporting structure 12 comprises a base 18 and at least one pair of uprights 16 that extend from the base 18 upward. The front edges 16a of said uprights are aligned along a common plane coincident with the supporting surface 14, i.e., inclined relative to the ground by an angle typically between 95° and 125°.

The panel, when loaded onto the device, is therefore resting on said front edges 16a of the uprights 16.

The device further comprises at least one lifting arm 22 inclusive of pick-up means 24 supported by a manipulating arm 38. As already mentioned, said lifting arm 22 is adapted to pick up a panel 26 from a stack of panels 28 arranged in front of said loading device 10.

In the example of the figures, the device is equipped with two lifting arms 22 although, as a function of the size and of the weight of the panels, said arms can also be three or more.

Again in the example of embodiment illustrated in FIG. 2, said pick-up means 24 comprise a support arm 25 and a plurality of vacuum suction cups 30.

The aforesaid vacuum suction cups 30 are connected to a vacuum device, such as a vacuum pump or a Venturi type suction system, not visible in the figure, adapted to produce a vacuum necessary to allow them to pick up.

According to an embodiment, said support arm 25 comprises a hollow section bar in fluid connection both with said vacuum suction cups 30 and with said vacuum device, so as to act as an air passage duct.

In the example of embodiment illustrated, said support arm 25 is hinged at one end to said manipulating arm 38.

As described previously, the stack 28 of panels generally comprises a few tens of panels with a thickness of a few millimetres which, increasingly frequently, are stacked with an irregular orientation of the faces to be machined, as the surfaces to be machined of said panels can be positioned, for example, facing toward or away from each other.

Once the suction cups 30 have been carried into contact with the surface A of the panel, surface of the upper face exposed at the top of said stack 28, thanks to the vacuum created by the vacuum device, they retain the panel 26, allowing the lifting arm 22 to carry out the pick-up and lifting operation, as can be seen in FIG. 3.

The suction cups 30 are arranged so as to serve a given surface area of a panel, corresponding approximately to the maximum size permitted by the work table P of the machine M.

Preferably, at least some of said vacuum suction cups 30 are provided with a valve connected to a feeler adapted to open the air suction passage only when these are in contact with a surface and said feeler is activated.

Preferably, said suction cups provided with said valve are located in the outermost part of the useful pick-up area of the panel.

In this way, in the case in which the surface area of the panel to be picked up is smaller than the maximum surface area, the suction cups 30 that do not come into contact with the surface A thereof are automatically excluded, so that the pneumatic circuit is in any case closed to obtain the vacuum on the other vacuum suction cups in contact with the panel.

With reference to the accompanying figures, said lifting arm 22 is hinged, by means of the end of the manipulating arm 38, to a carriage 32 sliding on a guide 34 extending prevalently vertically.

The guide 34 is in turn mounted on the base 18 of the supporting structure 12 by means of slides 36 sliding on tracks 37, so as to be able to vary their transverse (lateral) position relative to the uprights 16 and to the stack 28 of panels on the ground.

In fact, in the case of configuration of the device with two or more lifting arms 22, these can adapt to the width of the panel.

Actuator means, such as linear or rotary motors, not visible in the figure, are coupled to said lifting arm 22, to said carriage 32 and to said sliding guide 34, for very precise movement and position control of said lifting arm 22. Preferably, said motors are of brushless type and are associated with encoders for very precise position control.

These motors are connected to a control unit, for example a PLC, which manages their operating parameters according to a sequence of predetermined instructions. In particular, the PLC coordinates the activity of the aforesaid motors to obtain a fluid and optimized movement of the lifting arm 22.

As mentioned above, in FIG. 3 the loading device 10 is illustrated in a pick-up position where the pick-up means 24 grip the panel 26 on said first face A facing upward.

In FIGS. 4a and 4b the loading device 10 is instead represented in two loading steps, where in a first release position, represented in FIG. 4b, said panel is carried with said first face A onto the supporting surface 14 of the supporting structure 12, i.e., against the front edges 16a of the uprights 16, while the second opposite face B, the one facing downward in the stack 28, is facing outward.

In FIGS. 5a and 5b, the loading device 10 is instead represented in two loading steps, where in a second release position, represented in FIG. 5b, said panel is carried with the second face B on supporting surface 14 of the supporting structure 12, while the opposite first face A is facing outward.

As shown in FIGS. 4a, 4b, 5a, 5b, the movements of the carriage 32 and the rotations of the manipulating arm 38 and of the support arm 25 are coordinated so that the support arm 25 and the respective suction cups 30 are arranged, in the first and in the second release position, parallel to the supporting surface 14 and respectively beyond the supporting surface 14, toward the inside of the supporting structure 12, or outside it.

Preferably, at least one pair of lifting arms 22 are provided, so as to maintain the panel 26 balanced at all times during movement, and, in the case in which the panel is particularly wide or heavy, also three or four lifting arms 22 so as to be able to uniformly distribute the suction cups 30 mounted on each arm in a useful pick-up area.

In the pick-up position the support arms 25 are carried by said actuator means into a position substantially parallel to the surface of the panel on the stack 28 so that the suction cups 30 are pressed on the surface thereof in the same way.

Preferably, the suction system is already activated during descent of the support arms 2 toward the panel; when the active suction cups come into contact with the surface of the panel, closing the circuit, a sensor detects contact with the stack (which coincides with the pick-up position of the panel) and controls said actuator means for ascent toward the supporting surface 14.

According to the invention, support means are provided, adapted to support the panel in this release position, where the pick-up means 24 are deactivated.

In detail, said means comprise at least one pair of pins 44 mounted on the uprights 16 of the structure 12, so as to protrude beyond the supporting surface 14 and thus act as a support for the panel.

In detail, said pins are provided movable parallel to the supporting surface 14 along a substantially vertical direction, i.e. along the axis of these uprights 16, from a rest position in which they are preferably moved into the lower part of the upright allowing the panel to rest on the supporting surface 14, to an operating position, where there are carried into contact with the lower edge of the panel 26 facing downward, to support it.

In a preferred embodiment, said pins 44 are connected to the same number of actuators, not shown in the figure, mounted integral on the uprights, able to make them slide along the axis of the upright from said rest position to said operating position.

Once the pins 44 come into contact with the edge of the panel 26 facing downward, a sensor positioned on said actuator sends a signal to the suction system, which deactivates the suction cups 30.

In this the device is very flexible, as it can be adapted to panels of various heights which, understandably, would have different positioning, and in particular of the edge facing downward, in the release position on the supporting surface 14.

Moreover, the system thus configured allows the stack 28 of panels to be placed close to the device without a particular precise positioning.

In fact, any differences of a few centimetres (even up to 20-30 centimetres) are offset by the possibility of moving the guides 34 and, consequently, the respective lifting arms 22 transversely.

Thanks to the coplanarity between the supporting surface 14 of the device and the work table P of the machine tool, loading of the panel can take place by drawing the panel laterally on said pins until it is carried onto said work table P.

Said drawing can be carried out manually by the operator or, alternatively, an automatic device, such as an actuator, can be provided, which is able to push the panel from the supporting surface 14 onto the work table P.

In detail, the operation is simplified thanks to the movable pins 44, which are positioned by the actuators so that the edge of the panel facing downward is located substantially at the same height as a lower stop of the work table of the machine tool.

According to a preferred embodiment, said pins are also provided with sliding means, such as wheels, bearings or similar, which facilitate sliding of the panel onto the work table of the machine.

In FIG. 6, the number 110 illustrates the device for loading flat elements onto a machine tool according to another embodiment of the invention. According to this variant, the device comprises a supporting structure 112 that defines a substantially horizontal supporting surface 114.

The loading device according to this variant of the invention is provided to be positioned at an inlet of the machine tool (not illustrated in the figures) so that said supporting surface 114 is substantially parallel and coplanar to the work table P of the machine.

In the example illustrated in FIG. 9, the device 110 is placed next to a roller conveyor 200 which has the task of drawing the panel from supporting surface 114 toward the inlet of the machine tool.

According to a preferred embodiment, illustrated in FIGS. 6 to 14, said supporting structure 112 comprises a base 118 and profiles 116 (five in the example in the figure) arranged horizontally and preferably transverse to the direction of movement of the panel from the supporting surface 114 toward the machine tool.

Said profiles 116 are supported by feet 117 which, in turn, rest on the base 118.

The upper edges 116a of said profiles are aligned along a common plane coincident with the supporting surface 114, i.e., they are substantially horizontal.

The panel, when placed on the device, therefore rests on said upper edges 16a of the profiles 116.

In the example of the figures, a lifting arm, indicated as a whole with 122, is mounted on two of the aforesaid profiles 16. As a function of the size and of the weight of the flat elements, said arms can also be different in number, as can the profiles 116.

According to a preferred variant, said profiles 116 are mounted on the base 118 by means of slides 136 sliding on tracks 137 so as to be able to vary their transverse position, i.e., the distance from each other.

In fact, in the case of configuration of the device with two or more arms 22, these can adapt to the width of the flat element 26.

Said two arms 22 each comprise pick-up means 124 supported by a manipulating arm 138.

Again in the example of embodiment illustrated in FIGS. 6 to 14, said pick-up means 124 comprise a support arm 125 and a plurality of vacuum suction cups 130.

The aforesaid vacuum suction cups 130 are connected to a vacuum device, such as a vacuum pump or a Venturi type suction system, not visible in the figure, adapted to produce a vacuum necessary to allow them to pick up.

According to a preferred embodiment, said support arm 125 comprises an elongated body with an inner cavity fluidly connected both with said vacuum suction cups 30 and with said vacuum device, so as to act as an air passage duct.

More in detail, said pick-up means 124 comprise two rows of suction cups 30a, 30b placed on two opposite sides of the support arm 125 so as to be able to grip the flat element on two staggered pick-up surfaces.

In the example of embodiment illustrated, the support arm 125 is hinged at one end to said manipulating arm 138 by means of a motorized joint 126 with axis of rotation oriented parallel to the supporting surface 114 and parallel to the direction of movement of the panel from the supporting surface 114 toward the inlet of the machine tool.

The suction cups 130, once they have been carried into contact with the surface of the panel 28, retain it allowing the arm 122 to pick up, lift and/or overturn, as better explained hereunder.

The suction cups 130 are arranged so as to serve a given surface of a flat element, corresponding approximately to the maximum size permitted by the work table P of the machine tool.

Preferably, just as in the previous variant, at least some of said vacuum suction cups 130 are provided with a valve connected to a feeler adapted to open the air suction passage only when these are in contact with a surface and said feeler is activated.

Preferably, said suction cups provided with said valve are located in the outermost area of the useful pick-up area of the flat element.

With reference to the accompanying figures, the manipulating arm 138 is connected to a carriage 132 sliding on a guide 134 extending prevalently horizontally and oriented transverse, more precisely perpendicular, to the direction of movement of the panel from the supporting surface 114 to the work table of the machine tool.

More in detail, said manipulating arm 138 is hinged at one end to said carriage 132 by means of a motorized joint 140 with axis of rotation oriented parallel to the supporting surface 114 and to the direction of movement of the panel from said supporting surface 114 to the work table of the machine tool.

The guide 134 is fixed to one of the profiles 116 of the supporting structure 112 or, as in the example illustrated, to the feet 117.

Actuator means, such as a motor 133, are connected to the carriage 132 to move it along the guide 134.

Preferably, the motors that move the arm 122 and the carriage 132 are of brushless type and are associated with encoders for a very precise position control.

In the rest position, the arm 122 is folded on itself so that said support arm 125 is folded over said manipulating arm 138 and is placed, together with the suction cups 130, under the supporting surface 114, as illustrated in FIG. 8.

Again in said rest position the support arm 125 positions the first row of suction cups 130a facing upward and the second row of suction cups 130b facing downward.

According to a variant, not illustrated, the device can be equipped with movable stops, for example in the form of pins, protruding from the supporting surface 114. Said stops can be used to correctly position the panel 26 on the supporting surface 114 before its movement onto the work table of the machine.

In this way, regardless of the position of the stack 28 of panels on the ground and of the position in which the panel 26 is carried onto the supporting surface 114, said movable stop elements can be carried into contact with one or more edges of the panel to arrange it correctly for loading onto the machine tool, for example straightening it, if necessary, and/or arranging it with at least one of the lateral edges aligned with a reference of the machine tool.

In FIG. 9 the device 110 is illustrated arranged adjacent to a machine tool M, of which only the roller conveyor 200 at the inlet is depicted, which has the task of picking up the panel 26 from the supporting surface 114 and transferring it to the work table of the machine tool, not illustrated.

In the example of FIG. 9 and of FIGS. 10 to 16, two stacks 28a, 28b of panels 26 are arranged at respective opposite sides of the device 110. As can be noted from the accompanying FIGS. 11-16, the device 110 is able to pick up panels 26 indifferently from one or other stack.

In this way, when a stack of panels is finished, while an operator is removing the pallet of the empty stack and positioning a new stack, the device can continue to load panels from the other stack. Thanks to this configuration it is thus possible to operate the machine tool without interruptions, optimizing productivity.

This configuration also makes it possible to machine two different types of panel on the respective stacks, for example with different sizes, thicknesses or materials.

The operating mode of the device is substantially the same as that of the version with vertical work table.

In FIG. 10 the device 110 is in a rest or stand-by position.

In FIG. 11 the device 110 is illustrated in a pick-up position where the pick-up means 124 grip a panel 26 of the stack 28a on said first face A facing upward.

In FIGS. 12a and 12b the loading device 110 is instead represented in two loading steps, where in a first release position, represented in FIG. 12b, said panel 26 is carried with the second face B onto the supporting surface 114 of the supporting structure 112, i.e., resting on the upper edges 116a of the profiles 116 and with the first face A facing upward.

In FIGS. 13a and 13b the loading device 110 is instead represented in two loading steps, where in a second release position, represented in FIG. 13b, said panel 26 is carried with said first face A onto the supporting surface 114 of the supporting structure 112, while the second opposite face B is facing upward.

In FIG. 14 the device 110 is illustrated in a pick-up position, where the pick-up means 124 grip a panel 26 from the other stack 28b on said first face A facing upward.

In FIGS. 15a and 15b the loading device 110 is instead represented in two loading steps, where in a first release position, represented in FIG. 15b, said panel 26 is carried with the second face B onto the supporting surface 114 of the supporting structure 112, i.e., resting on the upper edges 116a of the profiles 116 and with the first face A facing upward.

In FIGS. 16a and 16b the loading device 110 is instead represented in two loading steps, where in a second release position, represented in FIG. 16b, said panel 26 is carried with said first face A onto the supporting surface 114 of the supporting structure 112, while the opposite second face B is facing upward.

As shown in the figures, the movements of the carriage 132 and the rotations of the manipulating arm 138 and of the support arm 125 are coordinated so that the support arm 125 and the respective suction cups 30 are arranged, in the first and in the second release position, parallel to the supporting surface 114 and respectively beyond the supporting surface 14, toward the inside of the supporting structure 112, or outside it.

In FIG. 17 the support arm 22 is illustrated according to another variant of the invention. According to this variant, the lifting arm comprises a spacer arm 139 interposed between the manipulating arm 138 and the support arm 125. As mentioned above, the lifting arm 22 with this configuration allows the manipulating arm 138 and the support arm 125 to be spaced apart when the panel is loaded in the first operating mode, i.e., maintaining the first face A of the panel facing upward. In particular, with this configuration it is possible to created more space to accommodate the panel between them in the release position.

This allows the panel to be gripped with a larger number of, or with all of the, suction cups 131. Moreover, it is possible to arrange the stacks of panels 28a, 28b closer to the device 110, as shown in FIGS. 18a to 18c.

Besides this, again in the release position described above, the lifting arm 22 remains substantially inside the footprint of the supporting surface 114.

The present invention, as described and illustrated, is susceptible to numerous modifications and variants all included in the inventive concept; moreover, all details can be replaced by other technically equivalent elements.

1. A device (10, 110) adapted to load flat elements, such as panels (26) or similar, onto a work table (P) of a machine tool (M), said device comprising:
a supporting structure (12, 112), defining a supporting surface (14, 114) substantially parallel to said work table (P), adapted to accommodate a panel (26) on said supporting surface (14), in a position to be able to be loaded onto said work table (P); and
at least one lifting arm (22, 122), connected to the supporting structure (12, 112), provided with pick-up means (24, 124), said lifting arm (22, 122) being configured to pick up a panel (26) from a stack (28) of panels and to position said panel (26) on the supporting surface (14, 114);
wherein the lifting arm (22, 122) comprises articulated elements and wherein the pick-up means (24, 124) are configured to rotate the panel (26) relative to a horizontal axis, parallel to the supporting surface (P) so that said lifting arm (22, 122) can, in a pick-up position, grip the panel (26) by a first face (A) facing upward and, in a first release position, position said panel (26) on said supporting surface (14, 114) with said first face (A) facing the latter or, in a second release position, position said panel (26) on said supporting surface (14, 114) with said first face (A) in the opposite direction, i.e., facing outward.

2. The device (10, 110) according to claim 1, comprising a movable support (32, 132), which can move along a direction substantially vertical, or in any case transverse to the ground, or substantially horizontal, to which said lifting arm (22, 122) is hinged.

3. The device (10, 110) according to claim 2, wherein the movable support comprises a carriage (32, 132) mounted sliding on a guide (34, 134) extending prevalently vertically or horizontally.

4. The device (10, 110) according to claim 3, wherein the guide (34, 134) is mounted on the supporting structure (12, 112) in a manner sliding along a horizontal direction, transverse to the direction of sliding of the carriage (32, 132) on the guide (34, 134) and parallel to the supporting surface (14, 114).

5. The device (10, 110) according to claim 1, wherein each lifting arm (22, 122) comprises a manipulating arm (38, 138) to which the pick-up means (24, 124) are rotatably connected.

6. The device (10, 110) according to claim 5, wherein each lifting arm (22, 122) comprises a spacer arm (139) interposed between the manipulating arm and the pick-up means (24, 124).

7. The device (10) according to claim 1, comprising support means (44) adapted to support said panel (26) in the aforesaid first and second release position.

8. The device (10) according to claim 7, wherein said support means (44) comprise at least one pair of pins protruding beyond the supporting surface (14) and movable parallel to said supporting surface (14) from a rest position, in which they allow the panel to rest on the supporting surface (14), to an operating position, where they are carried into contact with an edge of the panel (26) facing downward, to support it.

9. The device (10) according to claim 8, wherein said supporting structure (12) comprises a plurality of uprights (16) parallel to one another and inclined relative to the ground by an angle between 95° and 125°, said support means (44) being movable along the axis of said uprights (16), actuators adapted to control said movement being provided.

10. The device (110) according to claim 1, wherein said supporting structure (112) comprises a base (118) and profiles (116), supported by feet (117), arranged transverse to the direction of movement of the panel (26) from the supporting surface (114) toward the machine tool, the upper edges (116a) of said profiles (116) being aligned along a common plane coincident with the supporting surface (114).

11. The device (110) according to claim 3, wherein the guide (134) is fixed to one of the profiles (116) of the supporting structure (112) or to the feet (117).

12. The device (10, 110) according to claim 1, wherein said pick-up means (24, 124) comprise a support arm (25, 125) and a plurality of vacuum suction cups (30, 130a, 130b) mounted on said support arm (25, 125).

13. The device (10, 110) according to claim 12, wherein said vacuum suction cups (30, 130a, 130b) are provided with a valve connected to a feeler adapted to open the air suction passage only when these are in contact with a surface of the panel so that said feeler is activated.

14. The device (10, 110) according to claim 12, wherein the support arm (25, 125) is provided with at least one assembly of suction cups comprising at least one row of suction cups (30, 130a, 130b) aligned along the direction of extension of the support arm.

15. The device (110) according to claim 14, wherein the pick-up means (124) comprise at least two assemblies of suction cups (130a, 130b), the suction cups of each assembly being arranged aligned along respective pick-up surfaces, in general staggered and not necessarily parallel.
